(19) United States
(12) Patent Application Publication
(10) Pub. No.: US 2026/0217278 A1
(43) Pub. Date: Jul. 30, 2026

(54) AVOIDANCE PATH CALCULATION APPARATUS, AVOIDANCE PATH CALCULATION METHOD, AND MOBILE BODY

(71) Applicant: NEC Corporation, Tokyo (JP)

(72) Inventors: Yasuhiro MIZUKOSHI, Tokyo (JP); Yoshihiro MISHIMA, Tokyo (JP); Noritaka YAMASHITA, Tokyo (JP); Asako FUJII, Tokyo (JP)

(73) Assignee: NEC Corporation, Tokyo (JP)

(21) Appl. No.: 19/141,409

(22) PCT Filed: Dec. 27, 2022
(86) PCT No.: PCT/JP2022/048336

§ 371 Date: Jun. 20, 2025

(51) Int. Cl. B60W 60/00; B60W 30/09; B60W 30/095; G06V 20/58

(52) U.S. Cl. CPC B60W 60/0015; B60W 30/09; B60W 30/0956; G06V 20/58; B60W 2554/802; G06V 2201/08

(57) ABSTRACT

An information acquisition unit acquires stopped vehicle information regarding a stop situation of a stopped vehicle stopped in front of a mobile body. The stopped vehicle information includes information regarding a width and a length of the stopped vehicle, a position of the stopped vehicle in a traveling lane in which the mobile body is traveling, and a stop state of the stopped vehicle. An avoidance path calculation unit generates an avoidance path for the mobile body to travel while avoiding the stopped vehicle based on the stopped vehicle information. An avoidance path setting unit sets the avoidance path in the mobile body.

### TECHNICAL FIELD

The present disclosure relates to an avoidance path calculation apparatus, an avoidance path calculation method, a mobile body monitoring system, a mobile body, and a computer-readable medium.

### BACKGROUND ART

As the related art, Patent Literature 1 discloses a remote monitoring system that remotely monitors an autonomous vehicle. In the remote monitoring system described in Patent Literature 1, the autonomous vehicle includes an autonomous sensor including a camera. The autonomous vehicle detects an obstacle based on information obtained from the autonomous sensor. In a case where the autonomous vehicle detects an obstacle having a risk of collision, the vehicle is caused to travel at reduced speed. Further, the autonomous vehicle transmits a signal of reduced speed running and a camera image around the vehicle acquired using the camera to a remote monitoring center.

In the remote monitoring center, a monitoring person monitors the camera image around the vehicle received from the autonomous vehicle. The monitoring person checks a surrounding situation the autonomous vehicle from the camera image. In a case where the monitoring person determines that it is necessary to stop the autonomous vehicle, he/she causes the autonomous vehicle to stop. In a case where the monitoring person determines that it is safe to restart traveling, the monitoring person operates a human machine interface (HMI) and causes a computer at the monitoring center to transmit a departure signal to the autonomous vehicle. The autonomous vehicle continues to travel at reduced speed until receiving the departure signal or being instructed to stop. The autonomous vehicle restarts traveling in a case where receiving the departure signal.

### CITATION LIST

### Patent Literature

Patent Literature 1: Japanese Unexamined Patent Application Publication No. 2019-87015

### SUMMARY OF INVENTION

### Technical Problem

In general, in a case where another vehicle is parked or stopped in a traveling lane, a self-driving vehicle needs to overtake this vehicle. However, it is difficult for the self-driving vehicle to completely automatically overtake the stopped vehicle. At present, the determination of overtaking is often made by a remote monitoring person, and the remote monitoring person temporarily drives or operates the self-driving vehicle in a remote manner. In this case, the remote monitoring person can give an instruction on stop or departure to the self-driving vehicle after confirming a situation surrounding the vehicle with an image. However, in the related art including Patent Literature 1, there is a problem that the vehicle cannot be instructed on an appropriate path for avoiding the stopped vehicle.

In view of the above circumstances, an object of the present disclosure is to provide an avoidance path calculation apparatus, an avoidance path calculation method, a mobile body monitoring system, a mobile body, and a computer-readable medium capable of presenting a path for avoiding a vehicle to a mobile body in a case where the vehicle stopped in front of the mobile body exists.

### Solution to Problem

To achieve the above object, the present disclosure provides an avoidance path calculation apparatus as a first aspect. The avoidance path calculation apparatus includes: an information acquisition unit that acquires stopped vehicle information regarding a stop situation of a stopped vehicle stopped in front of a mobile body capable of automated driving, the stopped vehicle information including information regarding a width and a length of the stopped vehicle, a position of the stopped vehicle in a traveling lane in which the mobile body is traveling, and a stop state of the stopped vehicle; an avoidance path calculation unit that generates an avoidance path for the mobile body to travel while avoiding the stopped vehicle based on the stopped vehicle information; and an avoidance path setting unit that sets the avoidance path in the mobile body.

The present disclosure provides a mobile body as a second aspect. The mobile body includes: an automated driving control unit that causes the mobile body to run by automated driving; and an avoidance path calculation apparatus that generates an avoidance path for avoiding a stopped vehicle stopped in front of the mobile body. The avoidance path calculation apparatus includes: an information acquisition unit that acquires stopped vehicle information regarding a stop situation of the stopped vehicle, the stopped vehicle information including information regarding a width and a length of the stopped vehicle, a position of the stopped vehicle in a traveling lane in which the mobile body is traveling, and a stop state of the stopped vehicle; an avoidance path calculation unit that generates an avoidance path for the mobile body to travel while avoiding the stopped vehicle based on the stopped vehicle information; and an avoidance path setting unit that sets the avoidance path in the automated driving control unit.

The present disclosure provides, as a third aspect, a mobile body. The mobile body includes an automated driving control unit that causes the mobile body to run by automated driving. In a case where an avoidance path for avoiding a stopped vehicle stopped in front of the mobile body is set, the automated driving control unit causes the mobile body to travel along the set avoidance path, the avoidance path being generated based on stopped vehicle information regarding a stop situation of the stopped vehicle, the stopped vehicle information including information regarding a width and a length of the stopped vehicle, a position of the stopped vehicle in a traveling lane in which the mobile body is traveling, and a stop state of the stopped vehicle.

The present disclosure provides a mobile body monitoring system as a fourth aspect. The mobile body monitoring system includes a mobile body including an automated driving control unit that causes the mobile body to run by automated driving; a monitoring apparatus that monitors the mobile body; and an avoidance path calculation apparatus that generates an avoidance path for avoiding a stopped vehicle stopped in front of the mobile body. The avoidance path calculation apparatus includes: an information acquisition unit that acquires stopped vehicle information regarding a stop situation of the stopped vehicle, the stopped vehicle information including information regarding a width and a length of the stopped vehicle, a position of the stopped vehicle in a traveling lane in which the mobile body is traveling, and a stop state of the stopped vehicle; an avoidance path calculation unit that generates an avoidance path for the mobile body to travel while avoiding the stopped vehicle based on the stopped vehicle information; and an avoidance path setting unit that sets the avoidance path in the mobile body.

The present disclosure provides an avoidance path calculation method as a fifth aspect. The avoidance path calculation method includes: acquiring stopped vehicle information regarding a stop situation of a stopped vehicle stopped in front of a mobile body capable of automated driving, the stopped vehicle information including information regarding a width and a length of the stopped vehicle, a position of the stopped vehicle in a lane in which the mobile body is traveling, and a stop state of the stopped vehicle; generating an avoidance path for the mobile body to travel while avoiding the stopped vehicle based on the stopped vehicle information; and setting the avoidance path in the mobile body.

The present disclosure provides a computer-readable medium as a sixth aspect. The computer-readable medium stores a program for causing a computer to execute processing including: acquiring stopped vehicle information regarding a stop situation of a stopped vehicle stopped in front of a mobile body capable of automated driving, the stopped vehicle information including information regarding a width and a length of the stopped vehicle, a position of the stopped vehicle in a lane in which the mobile body is traveling, and a stop state of the stopped vehicle; generating an avoidance path for the mobile body to travel while avoiding the stopped vehicle based on the stopped vehicle information; and setting the avoidance path in the mobile body.

### Advantageous Effects of Invention

The avoidance path calculation apparatus, the avoidance path calculation method, the mobile body monitoring system, the mobile body, and the computer-readable medium according to the present disclosure can present the path for avoiding the vehicle to the mobile body in a case where the vehicle stopped in front of the mobile body exists.

### BRIEF DESCRIPTION OF DRAWINGS

FIG. 1 is a block diagram schematically illustrating a mobile body monitoring system according to the present disclosure.

FIG. 2 is a block diagram illustrating a mobile body monitoring system according to a first example embodiment of the present disclosure.

FIG. 3 is a block diagram illustrating a configuration example of a mobile body.

FIG. 4 is a block diagram illustrating a configuration example of a monitoring apparatus.

FIG. 5 is a block diagram illustrating an avoidance path calculation apparatus.

FIG. 6 is a view illustrating an input example of stopped vehicle information.

FIG. 7 is a schematic view illustrating a first specific example of avoidance path generation.

FIG. 8 is a schematic view illustrating a second specific example of the avoidance path generation.

FIG. 9 is a schematic view illustrating a third specific example of the avoidance path generation.

FIG. 10 is a schematic view illustrating a fourth specific example of the avoidance path generation.

FIG. 11 is a schematic view illustrating a fifth specific example of the avoidance path generation.

FIG. 12 is a schematic view illustrating a sixth specific example of the avoidance path generation.

FIG. 13 is a view illustrating an example of presentation of an avoidance path to a remote monitoring person.

FIG. 14 is a view illustrating another example of the presentation of the avoidance path to the remote monitoring person.

FIG. 15 is a flowchart illustrating an operation procedure in the first example embodiment.

FIG. 16 is a block diagram illustrating a configuration example of an avoidance path calculation apparatus used in a mobile body monitoring system according to a second example embodiment of the present disclosure.

FIG. 17 is a flowchart illustrating an operation procedure in the second example embodiment.

FIG. 18 is a block diagram illustrating a configuration example of a computer apparatus.

### EXAMPLE EMBODIMENT

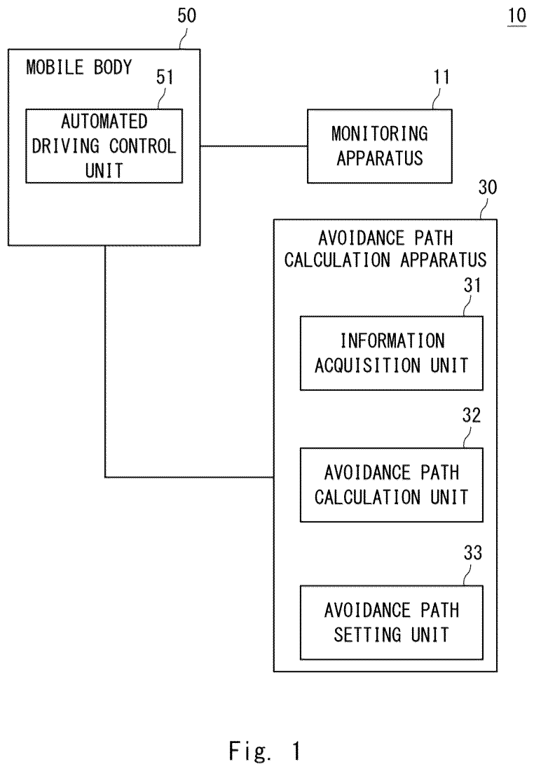

Prior to describing example embodiments of the present disclosure, an overview of the present disclosure will be given. FIG. 1 schematically illustrates a mobile body monitoring system according to the present disclosure. A mobile body monitoring system 10 includes a monitoring apparatus 11, an avoidance path calculation apparatus 30, and a mobile body 50. The mobile body 50 is configured to be capable of automated driving. The mobile body 50 includes an automated driving control unit 51 that drives the mobile body by automated driving. The monitoring apparatus 11 is an apparatus for monitoring the mobile body. The avoidance path calculation apparatus 30 is an apparatus that generates an avoidance path for avoiding a stopped vehicle stopped in front of the mobile body 50.

The avoidance path calculation apparatus 30 includes an information acquisition unit 31, an avoidance path calculation unit 32, and an avoidance path setting unit 33. The information acquisition unit 31 acquires stopped vehicle information regarding a stop situation of the stopped vehicle. The stopped vehicle information includes information regarding a width and a length of the stopped vehicle, a position of the stopped vehicle in a traveling lane in which the mobile body 50 is traveling, and a stop state of the stopped vehicle. The avoidance path calculation unit 32 generates an avoidance path for the mobile body 50 to travel while avoiding the stopped vehicle based on the stopped vehicle information. The avoidance path setting unit 33 sets the avoidance path in the mobile body 50.

In the present disclosure, the avoidance path calculation unit 32 generates the avoidance path for avoiding the stopped vehicle based on the stopped vehicle information regarding the stop situation of the stopped vehicle. The stopped vehicle information includes information such as the length, the width, and the position of the stopped vehicle, and the avoidance path calculation unit 32 can generate the path along which the mobile body 50 travels while avoiding the stopped vehicle by using these pieces of information. As described above, in a case where the vehicle stopped in front of the mobile body 50 exists, the path for avoiding the vehicle can be presented to the mobile body 50 in the present disclosure. The mobile body 50 can perform automated driving along the generated avoidance path and overtake the stopped vehicle.

Example embodiments according to the present disclosure will be described hereinafter in detail. Note that, in the following description and drawings, omission and simplification are made as appropriate for clarity of description. Further, the same elements and similar elements are denoted by the same reference signs throughout the drawings, and redundant description is omitted as necessary. Hereinafter, an example in which a mobile body is used in a country of left-hand traffic will be described. In the case of right-hand traffic, the left and right relationship may be appropriately interchanged and read.

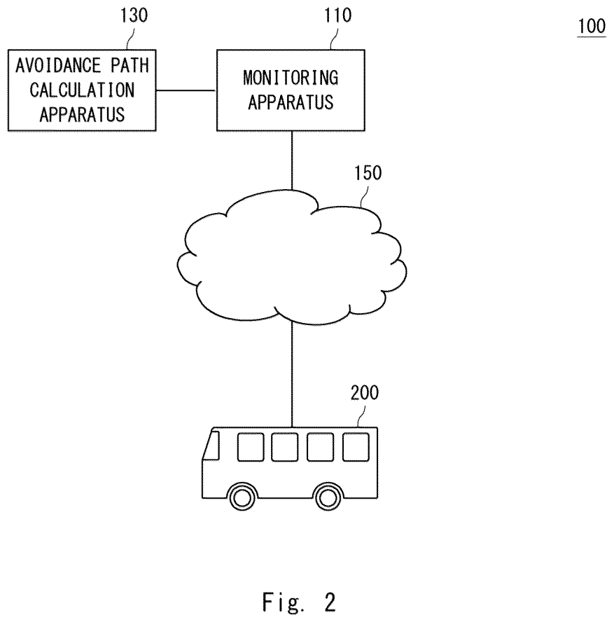

FIG. 2 illustrates a mobile body monitoring system according to a first example embodiment of the present disclosure. In the present example embodiment, the mobile body monitoring system is configured as a remote monitoring system that remotely monitors the mobile body. A remote monitoring system 100 includes a monitoring apparatus 110, an avoidance path calculation apparatus 130, and a mobile body 200. The monitoring apparatus 110 and the mobile body 200 are connected to each other via a network 150. The network 150 includes, for example, a wireless communication network using a communication line standard such as long term evolution (LTE). Alternatively, the network 150 may include a wireless communication network, such as WiFi (registered trademark) or a 5th generation mobile communication system. The remote monitoring system 100 corresponds to the mobile body monitoring system 10 illustrated in FIG. 1.

The mobile body 200 is configured as, for example, a vehicle traveling on a road, such as an automobile, a bus, or a taxi. The mobile body 200 may be configured such that automated driving (autonomous driving) is possible based on information from a sensor mounted on the mobile body. The monitoring apparatus 110 is a monitoring apparatus used by a monitoring person who monitors the mobile body 200. The monitoring apparatus 110 is disposed at, for example, a remote monitoring center. The monitoring apparatus 110 receives various types of data from the mobile body 200 via the network 150. Further, the monitoring apparatus 110 transmits various types of data to the mobile body 200 via the network 150. The avoidance path calculation apparatus 130 calculates an avoidance path for avoiding a stopped vehicle in a case where the mobile body 200 travels while avoiding the stopped vehicle in the front.

Note that FIG. 2 illustrates an example in which the remote monitoring system 100 includes only one mobile body 200, but the present example embodiment is not limited thereto. In the present example embodiment, the remote monitoring system 100 may be connected to a plurality of the mobile bodies 200 via the network 150. In this case, the monitoring apparatus 110 monitors the plurality of mobile bodies 200. In the present example embodiment, the monitoring apparatus 110 and the avoidance path calculation apparatus 130 are not necessarily different apparatuses that are physically separated. For example, the avoidance path calculation apparatus 130 may be included in the monitoring apparatus 110.

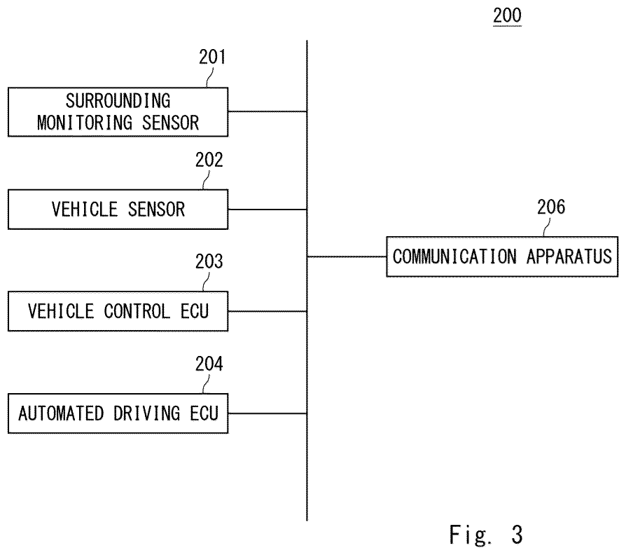

FIG. 3 illustrates a configuration example of the mobile body 200. The mobile body 200 includes a surrounding monitoring sensor 201, a vehicle sensor 202, a vehicle control electronic control unit (ECU) 203, an automated driving ECU 204, and a communication apparatus 205. In the mobile body 200, these components are configured to be able to communicate with one another through a network such as a local area network (LAN) or a controller area network (CAN). The mobile body 200 corresponds to the mobile body 50 illustrated in FIG. 1.

The surrounding monitoring sensor 201 is a sensor configured to monitor a surrounding situation of the mobile body 200. The surrounding monitoring sensor 201, for example, includes a camera, a radar, and a light detection and ranging (LiDAR). The surrounding monitoring sensor 201 may include, for example, a plurality of cameras to acquire images of areas of the front, rear, right, and left sides of the vehicle. The surrounding monitoring sensor 201 may include a camera to acquire an image of the interior of the mobile body 200.

The vehicle sensor 202 is a sensor that detects various states of the mobile body 200. The vehicle sensor 202 includes sensors such as a vehicle speed sensor that detects a vehicle speed, a steering sensor that detects a steering angle, an accelerator opening sensor that detects the degree of opening of an accelerator pedal, and a brake pedal force sensor that detects a depression amount of a brake pedal, and the like.

The vehicle control ECU 203 is an electronic control apparatus that performs travel control of the mobile body 200 or the like. In general, the electronic control apparatus includes a processor, a memory, an input/output (I/O), and a bus that connects them. Based on sensor information output by the vehicle sensor 202, the vehicle control ECU 203 executes various types of controls, such as control of a fuel injection amount, an engine ignition timing, and an assist amount of power steering. In a case where the mobile body 200 is a hybrid vehicle or an electric vehicle, the vehicle control ECU 203 may execute control.

The automated driving ECU 204 is an electronic control apparatus that controls automated driving of the mobile body 200. The automated driving ECU 204 acquires sensor information from the surrounding monitoring sensor 201 and the vehicle sensor 202, and controls automated traveling of the mobile body 200 based on the acquired sensor information. The automated driving ECU 204 causes the mobile body 200 to travel by automated driving along a preset route, for example. The mobile body 200 may be, for example, a self-driving bus. The automated driving ECU 204 corresponds to the automated driving control unit 51 illustrated in FIG. 1.

The communication apparatus 205 is configured as an apparatus that provides wireless communication between the mobile body 200 and the network 150 (see FIG. 2). The communication apparatus 205 includes a wireless communication antenna, a transmitter, and a receiver as a hardware configuration. Further, the communication apparatus 205 includes a processor, a memory, an I/O, and a bus that connects them. The function of each unit in the communication apparatus 205 is implemented, for example, in such a way that a control program stored in the memory is executed by the processor.

The communication apparatus 205 transmits various types of information acquired in the mobile body 200 to the monitoring apparatus 110 via the network 150. For example, the communication apparatus 205 acquires image data acquired by a camera included in the surrounding monitoring sensor 201, and transmits the acquired image data to the monitoring apparatus 110 via the network 150. The communication apparatus 205 may acquire sensor information acquired by the vehicle sensor 202 and transmit the acquired sensor information to the monitoring apparatus 110 via the network 150. The communication apparatus 205 may transmit position information of the mobile body 200 measured using, for example, a global navigation satellite system (GNSS) to the monitoring apparatus 110.

The communication apparatus 205 receives, for example, information regarding control of the mobile body 200 from the monitoring apparatus 110 via the network 150. The communication apparatus 205 receives, for example, remote control information which is information for remotely controlling the mobile body 200 from the monitoring apparatus 110. In a case where the remote control information is received, the communication apparatus 205 transmits the received remote control information to the vehicle control ECU 203 via an in-vehicle LAN or the like. The vehicle control ECU 203 controls the mobile body 200 based on the received remote control information.

Further, the communication apparatus 205 may receive automated driving control information, which is information for the controlling automated driving performed in the mobile body 200, from the monitoring apparatus 110. The automated driving control information includes, for example, information such as a parameter set in the automated driving ECU 204. In a case where the automated driving control information is received, the communication apparatus 205 transmits the received automated driving control information to the automated driving ECU 204 via the in-vehicle LAN or the like. The automated driving ECU 204 performs the automated driving of the mobile body 200 using the received parameter and the like.

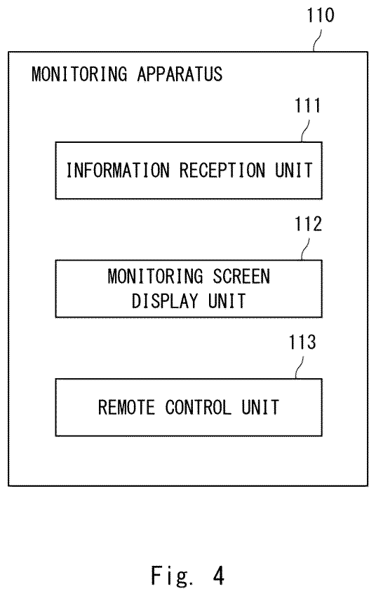

FIG. 4 illustrates a configuration example of the monitoring apparatus 110. The monitoring apparatus 110 includes an information reception unit 111, a monitoring screen display unit 112, and a remote control unit 113. The monitoring apparatus 110 can be configured as, for example, an apparatus including one or more memories and one or more processors. At least some of functions of the units in the monitoring apparatus 110 may be implemented in such a way that the one or more processors execute processing in accordance with a command read from the one or more memories. The monitoring apparatus 110 corresponds to the monitoring apparatus 11 illustrated in FIG. 1.

The information reception unit 111 receives information transmitted from the mobile body 200 via the network 150 (see FIG. 2). For example, the information reception unit 111 receives, from the mobile body 200, image data acquired by a camera included in the surrounding monitoring sensor 201. Further, the information reception unit 111 receives sensor information acquired by the vehicle sensor 202 from the mobile body 200.

The monitoring screen display unit 112 displays the information received by the information reception unit 111 on a screen of a display apparatus. For example, the monitoring screen display unit 112 displays image data of an area in front of the mobile body 200 on the screen. The monitoring screen display unit 112 may display various types of information such as a vehicle speed of the mobile body 200 on the display screen. The monitoring person monitors the operation of the mobile body 200 by observing the display screen.

The remote control unit 113 transmits information for remotely controlling the mobile body 200 to the mobile body 200 via the network 150. The remote control unit 113 may cause the monitoring person to select a remote control command such as right turn start, emergency stop, and start. In a case where the monitoring person selects the remote control command, the remote control unit 113 transmits the remote control command to the mobile body 200.

The remote control unit 113 may include equipment for remotely operating the vehicle, such as, for example, a steering wheel, an accelerator pedal, and a brake pedal. The monitoring person can operate the steering wheel and the like while viewing the screen displayed by the monitoring screen display unit 112. The remote control unit 113 transmits information indicating an opening degree of the accelerator, an operation amount of the steering wheel, a depression amount of the brake pedal, and the like to the mobile body 200. Furthermore, the remote control unit 113 may transmit information indicating the parameter of the automated driving to the mobile body 200.

In the present example embodiment, in a case where the mobile body 200 travels while avoiding a stopped vehicle in the front in the automated driving, the monitoring person is requested to confirm a surrounding situation. For example, in a case where it is necessary for the automated driving ECU 204 (see FIG. 3) of the mobile body 200 to overtake the stopped vehicle by protruding from a lane in which the mobile body 200 is traveling to another lane, the mobile body 200 is stopped behind the stopped vehicle. Further, the moving operation ECU 204 notifies the monitoring apparatus 110 that the mobile body 200 has stopped. In a case where the mobile body 200 stops behind the stopped vehicle, the monitoring apparatus 110 requests the avoidance path calculation apparatus 130 to calculate an avoidance path for avoiding the stopped vehicle.

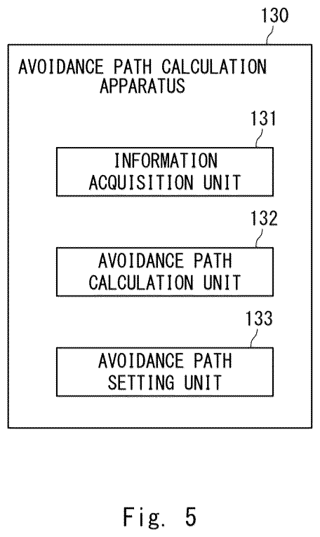

FIG. 5 illustrates a configuration example of the avoidance path calculation apparatus 130. The avoidance path calculation apparatus 130 includes an information acquisition unit 131, an avoidance path calculation unit 132, and an avoidance path setting unit 133. The avoidance path calculation apparatus 130 may be configured as, for example, an apparatus including one or more memories and one or more processors. At least some of functions of the units in the avoidance path calculation apparatus 130 may be implemented in such a way that the one or more processors execute processing in accordance with a command read from the one or more memories. The avoidance path calculation apparatus 130 corresponds to the avoidance path calculation apparatus 30 illustrated in FIG. 1.

The information acquisition unit 131 acquires stopped vehicle information regarding a stop situation of the stopped vehicle. The stopped vehicle information includes information regarding a width and a length of the stopped vehicle, a position of the stopped vehicle in the lane in which the mobile body 200 is traveling, and a stop state of the stopped vehicle. For example, the information acquisition unit 131 requests the monitoring person to input the stopped vehicle information. The monitoring person specifies the stopped vehicle using the image data displayed on the monitoring screen display unit 112 of the monitoring apparatus 110, and inputs information of the stopped vehicle to the information acquisition unit 131. The monitoring person can input the stopped vehicle information to the information acquisition unit 131 using an input device such as a keyboard, a pointing device, or a touch panel. The information acquisition unit 131 corresponds to the information acquisition unit 31 illustrated in FIG. 1.

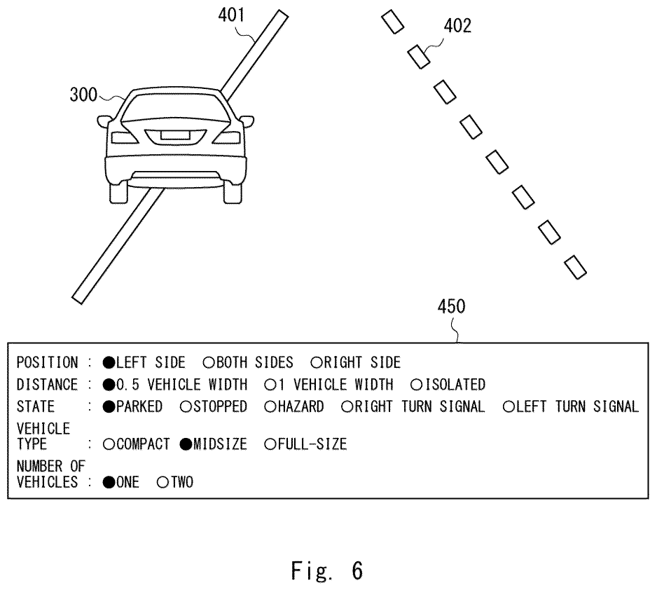

FIG. 6 illustrates an input example of the stopped vehicle information. The monitoring screen display unit 112 displays image data of an area in front of the mobile body 200 on the screen. The monitoring person recognizes a stopped vehicle 300 avoided by the mobile body 200 in the displayed image data. A traveling lane of the mobile body is defined by a left line 401 and a right line 402 that define a vehicle traffic lane. In FIG. 6, the left line 401 is assumed to be a line that defines a boundary between the traveling lane and a roadside strip. Further, the right line 402 is assumed to be a center line indicating a boundary between the traveling lane and the opposite lane.

The information acquisition unit 131 displays an information input area 450 on the display screen of the monitoring screen display unit 112. The information input area 450 includes items of the stopped vehicle information and options thereof. In FIG. 6, the stopped vehicle information includes a position, a distance, a state, a vehicle type, and the number of vehicles. The “position” indicates a position of the stopped vehicle 300 in the traveling lane of the mobile body 200. The “distance” indicates the amount of protrusion of the stopped vehicle 300 into the traveling lane of the mobile body 200. The “state” indicates a stop state of the stopped vehicle 300. The “vehicle type” indicates a vehicle type of the stopped vehicle 300. The “vehicle type” relates to a width and a length of the stopped vehicle 300. The “number of vehicles” indicates the number of the stopped vehicles 300. The information input area 450 and the image data of the mobile body 200 may be displayed on different screens. The items of the stopped vehicle information illustrated in FIG. 6 are examples, and the stopped vehicle information may include information of an item different from the above items.

The monitoring person inputs or selects information of the “position” of the stopped vehicle according to an overlapping state between the stopped vehicle 300 and a road sign that defines the traveling lane based on the image data. In a case where the stopped vehicle 300 is close to the left line 401 or the stopped vehicle 300 is crossing the left line 401, the monitoring person selects “left side” as the information of the “position”. In a case where the stopped vehicle 300 is close to the right line 402 or the stopped vehicle 300 is crossing the right line 402, the monitoring person selects “right side” as the information of the “position”. In a case where the stopped vehicle 300 is not close to either line, that is, in a case where the stopped vehicle 300 is stopped at a position between the left line 401 and the right line 402, the monitoring person selects “both sides” as the information of the “position”. In FIG. 6, the stopped vehicle 300 is crossing the left line 401, and thus “left side” is selected as the information of the “position”.

Further, the monitoring person determines the positional relationship between the stopped vehicle 300 and the road sign that defines the traveling lane of the mobile body 200 based on the image data. The monitoring person determines the amount of protrusion of the stopped vehicle 300 into the traveling lane based on the positional relationship. In other words, the monitoring person determines how much the stopped vehicle 300 protrudes from the road sign indicating a lane marking to the traveling lane. The monitoring person inputs or selects information of the “distance” of the stopped vehicle according to the amount of protrusion of the stopped vehicle 300 into the traveling lane.

For example, in a case where the stopped vehicle 300 protrudes from the left line 401 to the traveling lane by half the vehicle, the monitoring person selects “0.5 vehicle width” as the information of the “distance”. In a case where the stopped vehicle 300 is in contact with the left line 401, the monitoring person selects “1 vehicle width” as the information of the “distance”. In a case where the stopped vehicle 300 is separated from the left line 401 and the right line 402, the monitoring person selects “isolated” as the information of the “distance”. In FIG. 6, since the stopped vehicle 300 protrudes from the left line 401 to the traveling lane by half the vehicle, “0.5 vehicle width” is selected as the information of the “distance”.

The monitoring person determines a stop situation or a stop state of the stopped vehicle 300 based on the image data. For example, the monitoring person determines whether the stopped vehicle 300 is parked or the stopped vehicle is temporarily stopped. Further, the monitoring person determines lighting states of brake lamps and turn signals in the stopped vehicle based on the image data. For example, in a case where the brake lamps of the stopped vehicle 300 are not turned on and the turn signals are not activated, the monitoring person determines that the stopped vehicle 300 is parked. In this case, the monitoring person selects “parked” as the information of the “state”. For example, in a case where the brake lamps of the stopped vehicle 300 are turned on or any turn signal is activated, the monitoring person determines that the stopped vehicle 300 is stopped. In this case, the monitoring person selects “stopped” as the information of the “state”. In FIG. 6, it is determined that the stopped vehicle 300 is parked, and “parked” is selected as the information of the “state”.

The monitoring person determines the vehicle type of the stopped vehicle 300 based on the image data. Here, for example, “compact”, “midsize”, and “full-size” are considered as vehicle types of the vehicle. A “compact” vehicle is assumed to be a vehicle having a vehicle width of about 1.5 m and a vehicle length of about 3.5 m. A “midsize” vehicle is assumed to be a vehicle having a vehicle width of about 2 m and a vehicle length of about 5 m. A “full-size” vehicle is assumed to be a vehicle having a vehicle width of about 2.5 m and a vehicle length of about 12 m. The monitoring person selects “compact”, “midsize”, or “full-size” as the information of the “vehicle type” according to a determination result of the vehicle type. In FIG. 6, the stopped vehicle 300 is a typical passenger car, and “midsize” is selected as the information of the “vehicle type”. Instead of inputting the vehicle type of the stopped vehicle, the monitoring person may estimate a width and a length of the stopped vehicle from the image data and input the estimated width and length.

The monitoring person determines the number of the stopped vehicles 300 based on the image data. The monitoring person selects “1” or “2” as the information of the “number of vehicles” according to the number of the stopped vehicles 300. In a case where there are a plurality of stopped vehicles, the monitoring person may select the largest amount of protrusion among the amounts of protrusion of the respective stopped vehicles for the information of the “distance”. Further, in a case where there are a plurality of stopped vehicles, the monitoring person may select the largest vehicle type among the vehicle types of the respective stopped vehicles for the information of the “vehicle type”. Alternatively, the monitoring person may input the stopped vehicle information for each of the plurality of stopped vehicles.

Returning to FIG. 5, the avoidance path calculation unit 132 generates the avoidance path for the mobile body 200 to travel while avoiding the stopped vehicle based on the stopped vehicle information acquired by the information acquisition unit 131. For example, the avoidance path calculation unit 132 generates the avoidance path based on the information of the “position”, the “distance”, the “state”, the “vehicle type”, and the “number of vehicles” acquired as the stopped vehicle information. The avoidance path calculation unit 132 may determine an overtaking direction and a distance from an original traveling path based on the stopped vehicle information in generating the avoidance path. Note that the avoidance path calculation unit 132 does not necessarily generate the avoidance path using all the pieces of information of the “position”, the “distance”, the “state”, the “vehicle type”, and the “number of vehicles”. The avoidance path calculation unit 132 may generate the avoidance path using some of the pieces of information of the “position”, the “distance”, the “state”, the “vehicle type”, and the “number of vehicles”. Further, the avoidance path calculation unit 132 may generate the avoidance path using other information in addition to the stopped vehicle information.

For example, the avoidance path calculation unit 132 determines whether to overtake the stopped vehicle from the right or overtake the stopped vehicle from the left according to the “position” and the “state” in the stopped vehicle information. In a case where the “position” is “left side”, the avoidance path calculation unit 132 generates an avoidance path along which the mobile body 200 overtakes the stopped vehicle from the right side. On the other hand, in a case where the “position” is “right side”, the avoidance path calculation unit 132 generates the avoidance path along which the mobile body 200 overtakes the stopped vehicle from the left side. The avoidance path calculation unit 132 may determine from which side the stopped vehicle is to be overtaken depending on whether a hazard lamp is turned on or a right turn signal or a left turn signal is activated.

The avoidance path calculation unit 132 determines any distance by which the vehicle is to travel away from the original traveling path, that is, the amount of avoidance for avoiding the stopped vehicle according to the “distance” and the “vehicle type” in the stopped vehicle information. For example, the avoidance path calculation unit 132 generates an avoidance path along which the mobile body 200 travels away from the original traveling path by a distance corresponding to a vehicle width corresponding to the “vehicle type”. For example, the avoidance path calculation unit 132 generates an avoidance path along which the mobile body 200 travels away from the original traveling path by a distance obtained by adding a predetermined margin to the vehicle width corresponding to the vehicle type on the right side or the left side. The predetermined margin can be set to, for example, 50 cm.

In a case where there are a plurality of stopped vehicles, the avoidance path calculation unit 132 may generate the avoidance path according to a combination of pieces of the stopped vehicle information of the respective stopped vehicles. For example, in a case where the “positions” of two stopped vehicles are the same, the avoidance path calculation unit 132 may generate an avoidance path along which the mobile body 200 collectively overtakes the two stopped vehicles from the right side or the left side. In a case where there are two stopped vehicles, the “position” of a first stopped vehicle is “left side”, and the “position” of a second stopped vehicle is “right side”, the avoidance path calculation unit 132 may determine that overtaking is impossible.

The avoidance path calculation unit 132 may cause the monitoring screen display unit 112 of the monitoring apparatus 110 to display the avoidance path. In this case, the monitoring person can know which part of a road the mobile body 200 is to travel for overtaking the stopped vehicle 300.

The avoidance path calculation unit 132 may determine whether the mobile body 200 deviates from a road in a case where the mobile body 200 travels along the avoidance path using information of a lane width of the traveling lane. The avoidance path calculation unit 132 can acquire the lane width of the traveling lane from position information of the mobile body 200 using, for example, a database that holds lane width information in association with position information of the road. Alternatively, for example, the avoidance path calculation unit 132 may estimate the lane width from image data of an area in front of the vehicle acquired from the mobile body 200. Further, the avoidance path calculation unit 132 may acquire, from the database, information such as whether the road on which the mobile body 200 travels is one-way or two-way and whether there is a median strip. The avoidance path calculation unit 132 determines that there is no avoidance path in a case where a road width is narrow and thus there is no space for the mobile body 200 to overtake the stopped vehicle. In this case, the avoidance path calculation unit 132 may cause the monitoring screen display unit 112 to display that there is no avoidance path.

The avoidance path setting unit 133 sets the generated avoidance path in the mobile body 200. The avoidance path setting unit 133 may transmit the avoidance path to the mobile body 200 through, for example, the remote control unit 113 (see FIG. 4) of the monitoring apparatus 110. Alternatively, the avoidance path setting unit 133 may transmit the avoidance path to the mobile body 200 via the network 150. The mobile body 200 receives the avoidance path, and sets the received circuit path in the automated driving ECU 204 (see FIG. 4). The monitoring person can instruct the mobile body 200 to start, that is, start overtaking according to a situation around the mobile body 200. In a case where the start is instructed, the automated driving ECU 204 causes the mobile body 200 to travel along the set avoidance path.

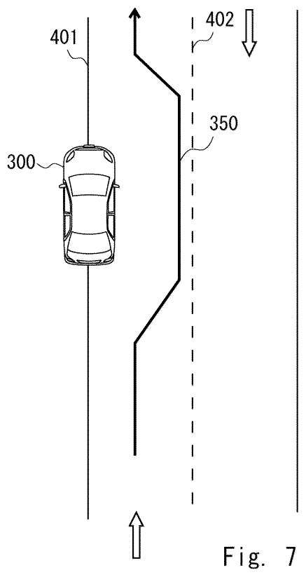

Hereinafter, some specific examples of avoidance path generation will be described. FIG. 7 illustrates a first specific example of the avoidance path generation. In this example, in the traveling lane of the mobile body 200, the stopped vehicle 300 is parked in the state of protruding from the left line 401 by about half the vehicle width. It is assumed that the “position” in the stopped vehicle information is “left side”, the “distance” is “0.5 vehicle width”, the “state” is “parked”, the “vehicle type” is “midsize”, and the “number of vehicles” is “one”. Note that it is assumed that the mobile body 200 linearly travels along the center of the traveling lane in a case where the stopped vehicle 300 does not exist.

In the first specific example, the avoidance path calculation unit 132 generates an avoidance path 350 along which the mobile body 200 overtakes the stopped vehicle 300 from the right side. The avoidance path calculation unit 132 generates the avoidance path 350 along which the mobile body 200 travels on the right side by a distance obtained by adding a predetermined margin to half the vehicle width of the “midsize” vehicle with respect to a traveling path of the mobile body 200 in a case where the stopped vehicle 300 does not exist. The predetermined margin can be set to, for example, 50 cm. In the avoidance path 350, the mobile body 200 goes out in front of the stopped vehicle 300 and then returns to the original traveling path.

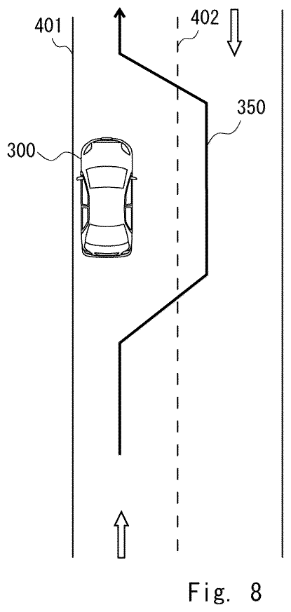

FIG. 8 illustrates a second specific example of the avoidance path generation. In this example, the stopped vehicle 300 is parked along the left line 401 in the traveling lane of the mobile body 200. It is assumed that the “position” in the stopped vehicle information is “left side”, the “distance” is “1 vehicle width”, the “state” is “parked”, the “vehicle type” is “midsize”, and the “number of vehicles” is “one”. In the second specific example, the avoidance path calculation unit 132 generates the avoidance path 350 to travel on the right side by a distance obtained by adding a predetermined margin to the vehicle width of the “midsize” vehicle with respect to the traveling path of the mobile body 200 in a case where the stopped vehicle 300 does not exist. In the avoidance path 350, the mobile body 200 goes out in front of the stopped vehicle 300 and then returns to the original traveling path.

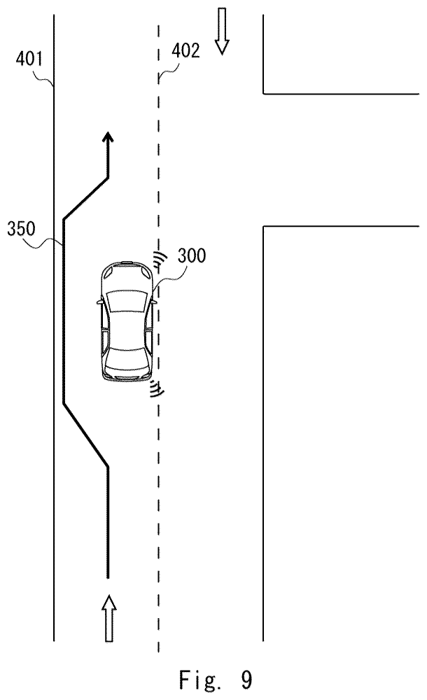

FIG. 9 illustrates a third specific example of the avoidance path generation. In this example, the stopped vehicle 300 is stopped along the right line 402 to wait for a right turn in the traveling lane of the mobile body 200. Further, the right turn signal of the stopped vehicle 300 is activated. It is assumed that the “position” in the stopped vehicle information is “right side”, the “distance” is “1 vehicle width”, the “state” is “stopped” and “right turn signal”, the “vehicle type” is “midsize”, and the “number of vehicles” is “one”. Note that the stopped vehicle 300 is stopped almost parallel to the right line 402 in FIG. 9, but the stopped vehicle information in a case where the stopped vehicle 300 is crossing the right line 402 and is obliquely stopped may be similar to that described above.

In the third specific example, the avoidance path calculation unit 132 generates the avoidance path 350 along which the mobile body 200 overtakes the stopped vehicle 300 from the left side. The avoidance path calculation unit 132 generates the avoidance path 350 along which the mobile body 200 travels on the left side by a distance obtained by adding a predetermined margin to the vehicle width of the “midsize” vehicle with respect to a traveling path of the mobile body 200 in a case where the stopped vehicle 300 does not exist. In the avoidance path 350, the mobile body 200 goes out in front of the stopped vehicle 300 and then returns to the original traveling path. If the mobile body 200 protrudes from the traveling lane in a case where the mobile body 200 travels along the avoidance path 350 and there is no space where the mobile body 200 can travel on the outer side of the left line 401, it is determined that overtaking is impossible.

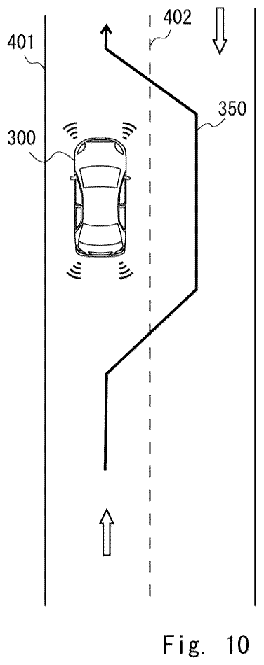

FIG. 10 illustrates a fourth specific example of the avoidance path generation. In this example, the stopped vehicle 300 turns on the hazard lamp and stops at a position away from the left line 401 and the right line 402 in the traveling lane of the mobile body 200. It is assumed that the “position” in the stopped vehicle information is “isolated”, the “distance” is “1 vehicle width”, the “state” is “stopped”, the “vehicle type” is “midsize”, and the “number of vehicles” is “one”. In the fourth specific example, the avoidance path calculation unit 132 generates the avoidance path 350 to travel on the right side at a distance separated by a width of one lane with respect to the traveling path of the mobile body 200 in a case where the stopped vehicle 300 does not exist. In the avoidance path 350, the mobile body 200 goes out in front of the stopped vehicle 300 and then returns to the original traveling path.

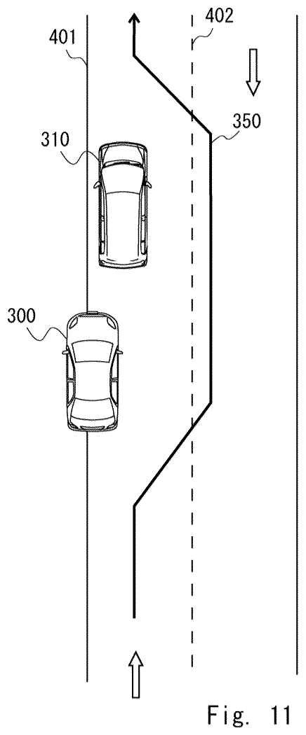

FIG. 11 illustrates a fifth specific example of the avoidance path generation. In this example, two stopped vehicles are stopped on the left side in the traveling lane in front of the mobile body 200. In the fifth specific example, the first stopped vehicle 300 is stopped or parked in the traveling lane of the mobile body 200 in the state of protruding from the left line 401 by about half the vehicle width. Further, a second stopped vehicle 310 is stopped or parked in the traveling lane of the mobile body 200 along the left line 401.

In the fifth specific example, the avoidance path calculation unit 132 generates the avoidance path 350 along which the mobile body 200 overtakes the stopped vehicles 300 and 310 from the right side. For example, the avoidance path calculation unit 132 generates the avoidance path 350 along which the mobile body 200 travels on the right side by a distance obtained by adding a predetermined margin to the vehicle width of the “midsize” vehicle with respect to a traveling path of the mobile body 200 in a case where the stopped vehicle 300 does not exist. The avoidance path calculation unit 132 may generate an avoidance path to overtake the stopped vehicle 300 along an avoidance path similar to the avoidance path in the first specific example for the first stopped vehicle 300 and to overtake the stopped vehicle 310 along an avoidance path similar to the avoidance path in the second specific example for the second stopped vehicle 310.

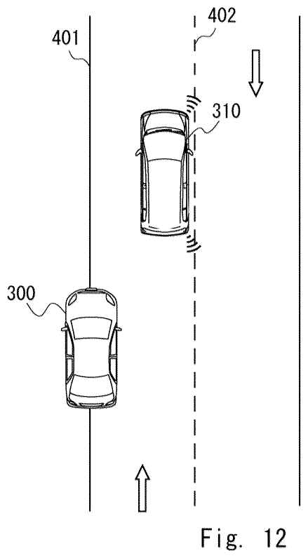

FIG. 12 illustrates a sixth specific example of the avoidance path generation. In this example, two stopped vehicles are stopped on the left side in the traveling lane in front of the mobile body 200. In the sixth specific example, the first stopped vehicle 300 is stopped or parked in the traveling lane of the mobile body 200 in the state of protruding from the left line 401 by about half the vehicle width. Further, the second stopped vehicle 310 is stopped along the right line 402 with a right turn signal being activated in the traveling lane of the mobile body 200. In this example, since the stopped vehicles exist on both the right side and the left side in the traveling lane, the avoidance path calculation unit 132 does not generate an avoidance path. In a case where a right turn of the second stopped vehicle 310 is completed and there is one stopped vehicle, the avoidance path calculation unit 132 may generate an avoidance path.

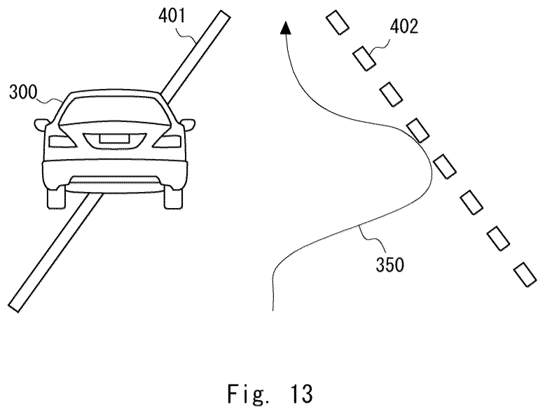

FIG. 13 illustrates an example of presentation of the avoidance path to the monitoring person. The monitoring screen display unit 112 of the monitoring apparatus 110 displays the image data of the area in front of the vehicle transmitted from the mobile body 200 on the display screen. Further, the monitoring screen display unit 112 displays the avoidance path 350 generated by the avoidance path calculation unit 132 of the avoidance path calculation apparatus 130 on the display screen. In this example, the avoidance path 350 indicates a trajectory through which a central portion of the mobile body 200 in a vehicle width direction passes. As illustrated in FIG. 13, the monitoring screen display unit 112 can display the avoidance path 350 superimposed on the image data. In this case, the monitoring person can easily grasp a situation of a stopped vehicle, a situation of another mobile body traveling in the opposite lane, and any part of a road in which the mobile body travels in overtaking of the stopped vehicle.

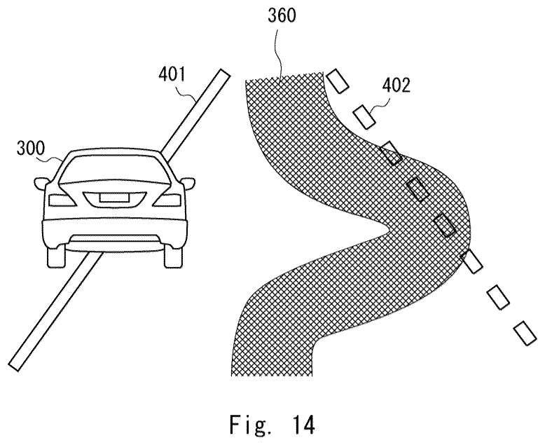

FIG. 14 illustrates another example of the presentation of the avoidance path to the monitoring person. In this example, an avoidance path 360 is displayed as an area corresponding to the vehicle width of the mobile body 200. In this case, as compared with the presentation of the avoidance path 350 illustrated in FIG. 13, the monitoring person can easily grasp any area of a road in which the mobile body 200 travels during traveling along the avoidance path.

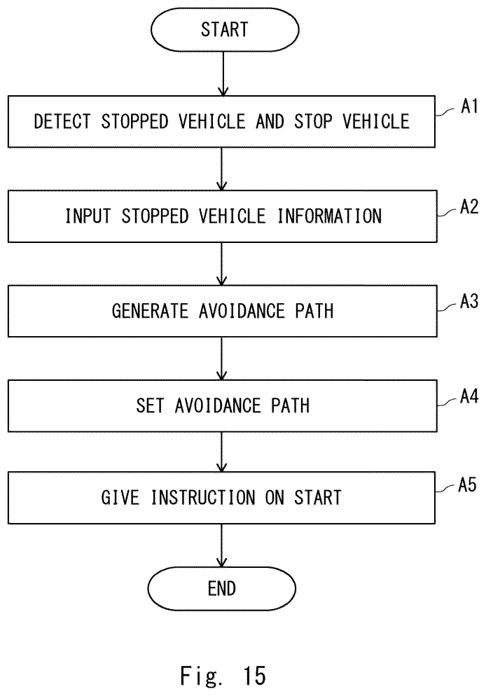

Next, an operation procedure will be described. FIG. 15 illustrates the operation procedure of the remote monitoring system 100. The communication apparatus 205 of the mobile body 200 transmits sensor data acquired by the surrounding monitoring sensor 201 to the monitoring apparatus 110. In the monitoring apparatus 110, the monitoring screen display unit 112 displays, for example, image data of an area in front of the mobile body 200. In a case where a stopped vehicle is detected in front of the mobile body 200 and it is necessary to avoid the stopped vehicle, the automated driving ECU 204 of the mobile body 200 stops the mobile body 200 (step A1). Further, the automated driving ECU 204 notifies the monitoring apparatus 110 and the avoidance path calculation apparatus 130 that a cause of the stop is the stopped vehicle.

The information acquisition unit 131 of the avoidance path calculation apparatus 130 requests the monitoring person to input stopped vehicle information. For example, the information acquisition unit 131 causes the monitoring screen display unit 112 to display the information input area 450 (see FIG. 6) for the input of the stopped vehicle information. The monitoring person inputs the stopped vehicle information (step A2). The information acquisition unit 131 transmits the stopped vehicle information input by the monitoring person to the avoidance path calculation unit 132. The avoidance path calculation unit 132 generates an avoidance path for the mobile body 200 to avoid the stopped vehicle based on the stopped vehicle information (step A3). The avoidance path setting unit 133 sets the avoidance path generated in Step A3 in the mobile body 200 (Step A4). Steps A2 to A4 correspond to an avoidance path calculation method performed by the avoidance path calculation apparatus 130.

The monitoring person checks a situation around the mobile body 200 and a situation of the opposite lane using the image data displayed on the monitoring screen display unit 112. The monitoring person instructs the mobile body 200 to start at a timing in a case where the mobile body 200 can safely overtake the stopped vehicle (step A5). In a case where the start is instructed, the automated driving ECU 204 in the mobile body 200 causes the mobile body 200 to travel along the avoidance path set in step A4 to overtake the stopped vehicle.

In the present example embodiment, the information acquisition unit 131 requests the monitoring person to input the stopped vehicle information regarding a stop situation of the stopped vehicle. The monitoring person inputs the stopped vehicle information used for the avoidance path generation. The avoidance path calculation unit 132 can generate the avoidance path for avoiding the stopped vehicle based on the stopped vehicle information input by the monitoring person. The avoidance path calculation apparatus 130 sets the generated avoidance path in the mobile body 200. As the mobile body 200 is caused to travel along the avoidance path set in the mobile body 200, the mobile body 200 can overtake the stopped vehicle along the appropriate avoidance path.

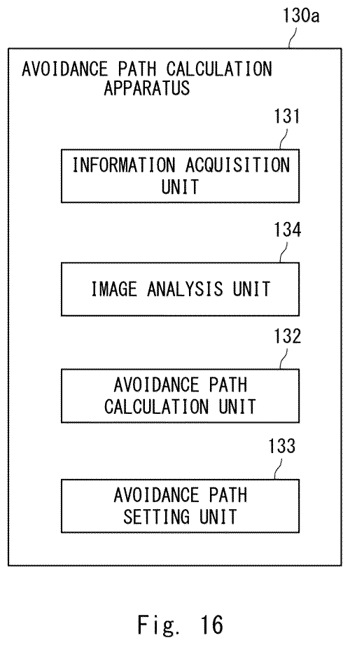

Next, a second example embodiment of the present disclosure will be described. FIG. 16 illustrates a configuration example of an avoidance path calculation apparatus used in a mobile body monitoring system according to a second example embodiment of the present disclosure. A configuration of the mobile body monitoring system in the present example embodiment may be similar to the configuration of the remote monitoring system 100 in the first example embodiment illustrated in FIG. 2. Further, configurations of the mobile body 200 and the monitoring apparatus 110 may be similar to those in the first example embodiment illustrated in FIGS. 3 and 4, respectively. An avoidance path calculation apparatus 130a used in the present example embodiment includes an image analysis unit 134 in addition to the constituent elements of the avoidance path calculation apparatus 130 used in the first example embodiment illustrated in FIG. 5.

In the present example embodiment, the image analysis unit 134 analyzes image data of an area in front of the mobile body 200 to acquire stopped vehicle information. The image analysis unit 134 performs, for example, lane detection and object detection on the image data. The image analysis unit 134 may determine an overlapping state between a lane and a stopped vehicle based on results of the lane detection and the object detection, and acquire a position of the stopped vehicle and the amount of protrusion into a traveling lane. Further, the image analysis unit 134 may acquire a vehicle type, a width, and a length of the stopped vehicle, and the number thereof from the result of the object detection. Further, the image analysis unit 134 may analyze lighting states of brake lamps and activation states of turn signals to acquire a stop state of the stopped vehicle. For example, the image analysis unit 134 may determine that the stopped vehicle is parked in a case where the brake lamps and the turn signals are not turned on, and may determine that the stopped vehicle is stopped in the other cases.

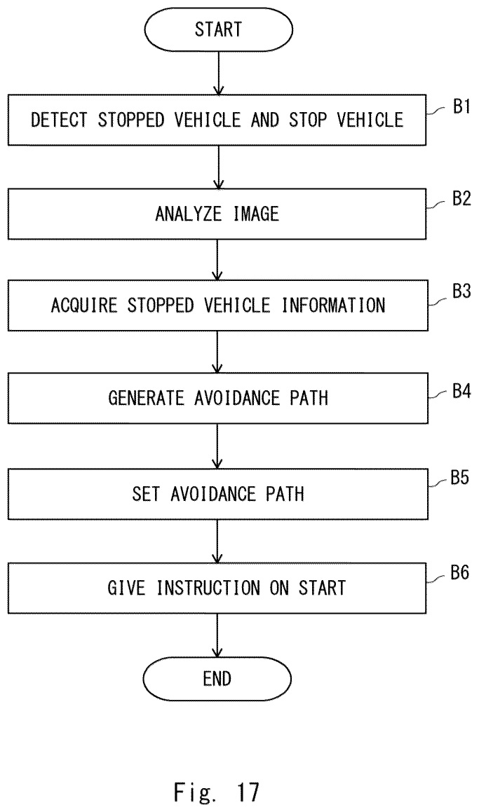

Next, an operation procedure will be described. FIG. 17 illustrates the operation procedure of the remote monitoring system 100 according to the present example embodiment. The communication apparatus 205 of the mobile body 200 transmits sensor data acquired by the surrounding monitoring sensor 201 to the monitoring apparatus 110. In the monitoring apparatus 110, the monitoring screen display unit 112 displays, for example, image data of an area in front of the mobile body 200. In a case where a stopped vehicle is detected in front of the mobile body 200 and it is necessary to avoid the stopped vehicle, the automated driving ECU 204 of the mobile body 200 stops the mobile body 200 (step B1). Further, the automated driving ECU 204 notifies the monitoring apparatus 110 and the avoidance path calculation apparatus 130 that a cause of the stop is the stopped vehicle. Step B1 may be similar to step A1 in FIG. 15.

The image analysis unit 134 of the avoidance path calculation apparatus 130 analyzes the image data of the area in front of the mobile body 200 and generates stopped vehicle information (step B2). Note that the stopped vehicle information generated in step B2 may be correctable by a monitoring person in the present example embodiment. For example, the monitoring screen display unit 112 displays the stopped vehicle information generated in step B2 on a display screen. The monitoring person can view the image data of the area in front of the mobile body 200 and manually correct at least some of pieces of information of items included in the stopped vehicle information.

The information acquisition unit 131 acquires the stopped vehicle information (step B3). In step B3, the information acquisition unit 131 acquires the stopped vehicle information generated in step B2 or the stopped vehicle information corrected by the monitoring person. The information acquisition unit 131 transmits the acquired stopped vehicle information to the avoidance path calculation unit 132.

The avoidance path calculation unit 132 generates an avoidance path for the mobile body 200 to avoid the stopped vehicle based on the stopped vehicle information (step B4). The avoidance path setting unit 133 sets the avoidance path generated in Step B4 in the mobile body 200 (Step B5). The monitoring person checks a situation around the mobile body 200 using the image data displayed on the monitoring screen display unit 112. The monitoring person instructs the mobile body 200 to start at a timing in a case where the mobile body 200 can safely overtake the stopped vehicle (step B6). Steps B4 to B6 may be similar to steps A3 to A5 illustrated in FIG. 15.

In the present example embodiment, the image analysis unit 134 analyzes the image data of the area in front of the mobile body 200 and generates the stopped vehicle information. In the present example embodiment, since the stopped vehicle information can be acquired by analyzing the image data, a load on the monitoring person can be reduced as compared with the first example embodiment. Other effects are similar to those in the first example embodiment.

Note that an example in which the monitoring apparatus 110 and the mobile body 200 are connected via the network 150 and the monitoring person remotely monitors the mobile body 200 has been described in the above example embodiments. However, the present disclosure is not limited thereto. For example, the mobile body 200 may include the monitoring apparatus 110, and in the mobile body 200, an occupant riding on the mobile body may monitor the operation of the mobile body 200. In such a case, it is sufficient for the occupant who is a monitoring person to be capable of giving a necessary instruction to the mobile body 200, and does not need to have the ability to drive the mobile body 200. In other words, the occupant does not need to have a qualification or a license for driving the mobile body 200.

Further, an example in which the avoidance path calculation apparatus 130 sets the avoidance path in the mobile body 200 via the network 150 has been described in the above example embodiments. However, the present disclosure is not limited thereto. The avoidance path calculation apparatus 130 may be mounted on the mobile body 200. In this case, the information acquisition unit 131 of the avoidance path calculation apparatus 130 may acquire the stopped vehicle information input by the monitoring person via the network 150. Further, all the functions in the avoidance path calculation apparatus 130 are not necessarily mounted on the mobile body 200, but some of the functions may be mounted on the mobile body 200 and the remaining functions may be disposed in a remote monitoring center.

In the above example embodiments, an example in which, in a case where a stopped vehicle is detected in automated driving, the mobile body 200 stops behind the stopped vehicle and the avoidance path is generated has been described. However, the present disclosure is not limited thereto. In a case where a stopped vehicle is detected, the mobile body 200 does not necessarily stop behind the stopped vehicle. Further, in the present disclosure, the mobile body 200 does not need to wait for the instruction from the monitoring person for overtaking the stopped vehicle, and the mobile body 200 may check the surrounding situation and then automatically overtake the stopped vehicle. For example, the mobile body 200 may automatically overtake the stopped vehicle without stopping in a case where the generated avoidance path is set during traveling and the surrounding situation allows overtaking.

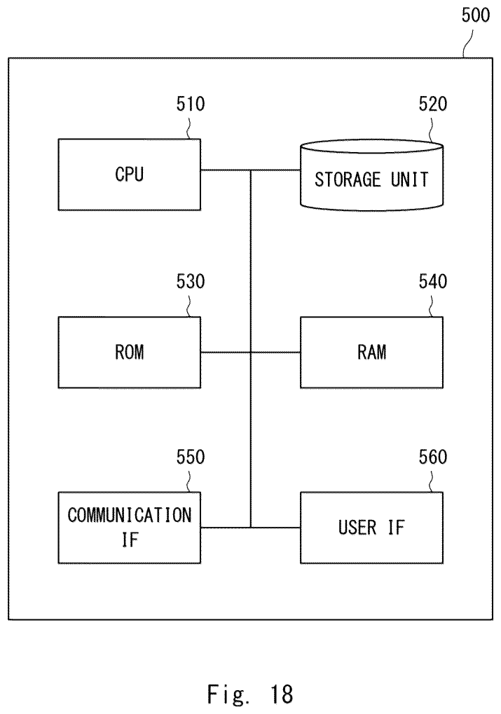

In the present disclosure, each of the monitoring apparatus 110 and the avoidance path calculation apparatus 130 can be configured as a computer apparatus. FIG. 18 illustrates a configuration example of the computer apparatus that can be used as the monitoring apparatus 110 and the avoidance path calculation apparatus 130. A computer apparatus 500 includes a control unit (central processing unit (CPU)) 510, a storage unit 520, a read only memory (ROM) 530, a random access memory (RAM) 540, a communication interface (IF) 550, and a user interface (IF) 560.

The communication interface 550 is an interface connecting the computer apparatus 500 to a communication network through wired communication means, wireless communication means, or the like. The user interface 560 includes, for example, a display unit such as a display. Further, the user interface 560 includes an input unit such as a keyboard, a mouse, and a touch panel.

The storage unit 520 is an auxiliary storage device that can retain various types of data. The storage unit 520 is not necessarily a part of the computer apparatus 500, and may be an external storage device or a cloud storage connected to the computer apparatus 500 via a network.

The ROM 530 is a nonvolatile storage device. For example, a semiconductor storage device such as a flash memory that has a relatively compact capacity may be used for the ROM 530. A program that is executed by the CPU 510 may be stored in the storage unit 520 or the ROM 530. The storage unit 520 or the ROM 530 stores, for example, various programs for implementing the functions of the respective units in the monitoring apparatus 110 or the avoidance path calculation apparatus 130.

The above-described programs can be stored and supplied to the computer apparatus 500 using various types of non-transitory computer-readable media. The non-transitory computer-readable media include various types of tangible storage media. Examples of the non-transitory computer-readable media include magnetic storage media such as floppy disks, magnetic tapes, and hard disk drives, optical magnetic storage media such as magneto-optical disks, optical disk media such as compact disc (CD) and digital versatile disk (DVD), and semiconductor memories such as mask ROM, programmable ROM (PROM), erasable PROM (EPROM), flash ROM, and RAM. Further, the programs may be provided to computers using various types of transitory computer-readable media. Examples of the transitory computer-readable media include electric signals, optical signals, and electromagnetic waves. The transitory computer-readable media can supply the programs to the computer via a wired communication line such as an electric wire or an optical fiber, or a wireless communication line.

The RAM 540 is a volatile storage device. As the RAM 540, various types of semiconductor memory devices such as a dynamic random access memory (DRAM) or a static random access memory (SRAM) may be used. The RAM 540 may be used as an internal buffer that temporarily stores data or the like. The CPU 510 loads a program stored in the storage unit 520 or the ROM 530, in the RAM 540 and executes the loaded program. The function of each unit in the monitoring apparatus 110 or the avoidance path calculation apparatus 130 can be implemented by the CPU 510 executing the program. The CPU 510 may include an internal buffer in which data or the like can be temporarily stored.

Although the example embodiments of the present disclosure have been described above in detail, the present disclosure is not limited to the above example embodiments, and the present disclosure also includes changes or modifications made to the above example embodiments without departing from the scope of the present disclosure.

For example, some or all of the above-described example embodiments may be described as the following Supplementary Notes, but the present disclosure is not limited to the following Supplementary Notes.

### Supplementary Note 1

An avoidance path calculation apparatus including:
an information acquisition unit configured to acquire stopped vehicle information regarding a stop situation of a stopped vehicle stopped in front of a mobile body capable of automated driving, the stopped vehicle information including information regarding a width and a length of the stopped vehicle, a position of the stopped vehicle in a traveling lane in which the mobile body is traveling, and a stop state of the stopped vehicle;
an avoidance path calculation unit configured to generate an avoidance path for the mobile body to travel while avoiding the stopped vehicle based on the stopped vehicle information; and
an avoidance path setting unit configured to set the avoidance path in the mobile body.

### Supplementary Note 2

The avoidance path calculation apparatus according to Supplementary Note 1, wherein the information acquisition unit acquires, as the position of the stopped vehicle, information indicating whether the stopped vehicle is close to a left line that defines the traveling lane and information indicating whether the stopped vehicle is close to a right line that defines the traveling lane.

### Supplementary Note 3

The avoidance path calculation apparatus according to Supplementary Note 2, wherein the avoidance path calculation unit generates the avoidance path in such a manner as to cause the mobile body to avoid the stopped vehicle from a right side of the stopped vehicle in a case where the information indicating that the stopped vehicle is close to the left line is acquired as the position of the stopped vehicle, and generates the avoidance path in such a manner as to cause the mobile body to avoid the stopped vehicle from a left side of the stopped vehicle in a case where the information indicating that the stopped vehicle is close to the right line is acquired as the position of the stopped vehicle.

### Supplementary Note 4The avoidance path calculation apparatus according to Supplementary Note 2 or 3, wherein

the stopped vehicle information further includes a distance indicating any amount of protrusion from the left line or the right line into the traveling lane, and
the avoidance path calculation unit determines an amount of avoidance for avoiding the stopped vehicle in accordance with the distance included in the stopped vehicle information.

### Supplementary Note 5

The avoidance path calculation apparatus according to any one of Supplementary Notes 1 to 4, wherein the information acquisition unit acquires a vehicle type of the stopped vehicle as the information regarding the width and the length of the stopped vehicle.

### Supplementary Note 6

The avoidance path calculation apparatus according to any one of Supplementary Notes 1 to 5, wherein the information acquisition unit displays items of the stopped vehicle information and options of each of the items on a display screen of a display apparatus, and requests a monitoring person who monitors the mobile body to input the stopped vehicle information.

### Supplementary Note 7

The avoidance path calculation apparatus according to any one of Supplementary Notes 1 to 5, further including an image analysis unit configured to analyze image data of an area in front of the mobile body and to generate the stopped vehicle information.

### Supplementary Note 8

A mobile body including:
an automated driving control unit configured to cause the mobile body to run by automated driving; and
an avoidance path calculation apparatus configured to generate an avoidance path for avoiding a stopped vehicle stopped in front of the mobile body,
an information acquisition unit configured to acquire stopped vehicle information regarding a stop situation of the stopped vehicle, the stopped vehicle information including information regarding a width and a length of the stopped vehicle, a position of the stopped vehicle in a traveling lane in which the mobile body is traveling, and a stop state of the stopped vehicle;
an avoidance path calculation unit configured to generate an avoidance path for the mobile body to travel while avoiding the stopped vehicle based on the stopped vehicle information; and
an avoidance path setting unit configured to set the avoidance path in the automated driving control unit.

### Supplementary Note 9

The mobile body according to Supplementary Note 8, wherein the information acquisition unit acquires, as the position of the stopped vehicle, information indicating whether the stopped vehicle is close to a left line that defines the traveling lane and information indicating whether the stopped vehicle is close to a right line that defines the traveling lane.

### Supplementary Note 10

The mobile body according to Supplementary Note 9, wherein
the stopped vehicle information further includes a distance indicating any amount of protrusion from the left line or the right line into the traveling lane, and
the avoidance path calculation unit determines an amount of avoidance for avoiding the stopped vehicle in accordance with the distance included in the stopped vehicle information.

### Supplementary Note 11

A mobile body including an automated driving control unit configured to cause the mobile body to run by automated driving,
wherein in a case where an avoidance path for avoiding a stopped vehicle stopped in front of the mobile body is set, the automated driving control unit causes the mobile body to travel along the set avoidance path, the avoidance path being generated based on stopped vehicle information regarding a stop situation of the stopped vehicle, the stopped vehicle information including information regarding a width and a length of the stopped vehicle, a position of the stopped vehicle in a traveling lane in which the mobile body is traveling, and a stop state of the stopped vehicle.

### Supplementary Note 12

The mobile body according to Supplementary Note 11, wherein the position of the stopped vehicle includes information indicating whether the stopped vehicle is close to a left line that defines the traveling lane and information indicating whether the stopped vehicle is close to a right line that defines the traveling lane.

### Supplementary Note 13

The mobile body according to Supplementary Note 12, wherein
the stopped vehicle information further includes a distance indicating any amount of protrusion from the left line or the right line into the traveling lane, and
in generating the avoidance path, an amount of avoidance for avoiding the stopped vehicle is determined in accordance with the distance included in the stopped vehicle information.

### Supplementary Note 14

A mobile body monitoring system including:
a mobile body that includes an automated driving control unit configured to cause the mobile body to run by automated driving;
a monitoring apparatus configured to monitor the mobile body; and
an avoidance path calculation apparatus configured to generate an avoidance path for avoiding a stopped vehicle stopped in front of the mobile body,
wherein the avoidance path calculation apparatus includes:
an information acquisition unit configured to acquire stopped vehicle information regarding a stop situation of the stopped vehicle, the stopped vehicle information including information regarding a width and a length of the stopped vehicle, a position of the stopped vehicle in a traveling lane in which the mobile body is traveling, and a stop state of the stopped vehicle;
an avoidance path calculation unit configured to generate an avoidance path for the mobile body to travel while avoiding the stopped vehicle based on the stopped vehicle information; and
an avoidance path setting unit configured to set the avoidance path in the mobile body.

### Supplementary Note 15

The mobile body monitoring system according to Supplementary Note 14, wherein the monitoring apparatus displays the avoidance path on a display screen of a display apparatus.

### Supplementary Note 16

The mobile body monitoring system according to Supplementary Note 15, wherein the monitoring apparatus displays the avoidance path to be superimposed on image data acquired from the mobile body.

### Supplementary Note 17

The mobile body monitoring system according to Supplementary Note 15 or 16, wherein the monitoring apparatus displays the avoidance path as an area corresponding to a width of the mobile body.

### Supplementary Note 18

The mobile body monitoring system according to any one of Supplementary Notes 14 to 17, wherein the information acquisition unit acquires, as the position of the stopped vehicle, information indicating whether the stopped vehicle is close to a left line that defines the traveling lane and information indicating whether the stopped vehicle is close to a right line that defines the traveling lane.

### Supplementary Note 19

The mobile body monitoring system according to Supplementary Note 18, wherein
the stopped vehicle information further includes a distance indicating any amount of protrusion from the left line or the right line into the traveling lane, and
the avoidance path calculation unit determines an amount of avoidance for avoiding the stopped vehicle in accordance with the distance included in the stopped vehicle information.

### Supplementary Note 20

An avoidance path calculation method including:
acquiring stopped vehicle information regarding a stop situation of a stopped vehicle stopped in front of a mobile body capable of automated driving, the stopped vehicle information including information regarding a width and a length of the stopped vehicle, a position of the stopped vehicle in a lane in which the mobile body is traveling, and a stop state of the stopped vehicle;
generating an avoidance path for the mobile body to travel while avoiding the stopped vehicle based on the stopped vehicle information; and
setting the avoidance path in the mobile body.

### Supplementary Note 21

A non-transitory computer-readable medium storing a program for causing a computer to execute processing including:
acquiring stopped vehicle information regarding a stop situation of a stopped vehicle stopped in front of a mobile body capable of automated driving, the stopped vehicle information including information regarding a width and a length of the stopped vehicle, a position of the stopped vehicle in a lane in which the mobile body is traveling, and a stop state of the stopped vehicle;
generating an avoidance path for the mobile body to travel while avoiding the stopped vehicle based on the stopped vehicle information; and
setting the avoidance path in the mobile body.

### REFERENCE SIGNS LIST

10 MOBILE BODY MONITORING SYSTEM
11 MONITORING APPARATUS
30 AVOIDANCE PATH CALCULATION APPARATUS
31 INFORMATION ACQUISITION UNIT
32 AVOIDANCE PATH CALCULATION UNIT
33 AVOIDANCE PATH SETTING UNIT
50 MOBILE BODY
51 AUTOMATED DRIVING CONTROL UNIT
100 REMOTE MONITORING SYSTEM
110 MONITORING APPARATUS
111 INFORMATION RECEPTION UNIT
112 MONITORING SCREEN DISPLAY UNIT
113 REMOTE CONTROL UNIT
130 AVOIDANCE PATH CALCULATION APPARATUS
131 INFORMATION ACQUISITION UNIT
132 AVOIDANCE PATH CALCULATION UNIT
133 AVOIDANCE PATH SETTING UNIT
500 COMPUTER APPARATUS
510 CONTROL UNIT
520 STORAGE UNIT
530 ROM
540 RAM
550 COMMUNICATION INTERFACE
560 USER INTERFACE

What is claimed is:

1. An avoidance path calculation apparatus comprising:
at least one memory storing instructions; and
at least one processor configured to execute the instructions to:
acquire stopped vehicle information regarding a stop situation of a stopped vehicle stopped in front of a mobile body capable of automated driving, the stopped vehicle information including information regarding a width and a length of the stopped vehicle, a position of the stopped vehicle in a traveling lane in which the mobile body is traveling, and a stop state of the stopped vehicle;
generate an avoidance path for the mobile body to travel while avoiding the stopped vehicle based on the stopped vehicle information; and
set the avoidance path in the mobile body.

2. The avoidance path calculation apparatus according to claim 1, wherein the at least one processor is configured to execute the instructions to acquire, as the position of the stopped vehicle, information indicating whether the stopped vehicle is close to a left line that defines the traveling lane and information indicating whether the stopped vehicle is close to a right line that defines the traveling lane.

3. The avoidance path calculation apparatus according to claim 2, wherein the at least one processor is configured to execute the instructions to generate the avoidance path in such a manner as to cause the mobile body to avoid the stopped vehicle from a right side of the stopped vehicle in a case where the information indicating that the stopped vehicle is close to the left line is acquired as the position of the stopped vehicle, and generate the avoidance path in such a manner as to cause the mobile body to avoid the stopped vehicle from a left side of the stopped vehicle in a case where the information indicating that the stopped vehicle is close to the right line is acquired as the position of the stopped vehicle.

4. The avoidance path calculation apparatus according to claim 2, wherein
the stopped vehicle information further includes a distance indicating any amount of protrusion from the left line or the right line into the traveling lane, and
the at least one processor is configured to execute the instructions to determine an amount of avoidance for avoiding the stopped vehicle in accordance with the distance included in the stopped vehicle information.

5. The avoidance path calculation apparatus according to claim 1, wherein the at least one processor is configured to execute the instructions to acquire a vehicle type of the stopped vehicle as the information regarding the width and the length of the stopped vehicle.

6. The avoidance path calculation apparatus according to claim 1, wherein the at least one processor is configured to execute the instructions to display items of the stopped vehicle information and options of each of the items on a display screen of a display apparatus, and request a monitoring person who monitors the mobile body to input the stopped vehicle information.

7. The avoidance path calculation apparatus according to claim 1, wherein the at least one processor is configured to execute the instructions to analyze image data of an area in front of the mobile body and to generate the stopped vehicle information.

8. A mobile body comprising:
an automated driving controller configured to cause the mobile body to run by automated driving; and
an avoidance path calculation apparatus configured to generate an avoidance path for avoiding a stopped vehicle stopped in front of the mobile body,
wherein the avoidance path calculation apparatus comprises:
at least one memory storing instructions; and
at least one processor configured to execute the instructions to:
acquire stopped vehicle information regarding a stop situation of the stopped vehicle, the stopped vehicle information including information regarding a width and a length of the stopped vehicle, a position of the stopped vehicle in a traveling lane in which the mobile body is traveling, and a stop state of the stopped vehicle;
generate an avoidance path for the mobile body to travel while avoiding the stopped vehicle based on the stopped vehicle information; and
set the avoidance path in the automated driving control unit.

9. The mobile body according to claim 8, wherein the at least one processor is configured to execute the instructions to acquire, as the position of the stopped vehicle, information indicating whether the stopped vehicle is close to a left line that defines the traveling lane and information indicating whether the stopped vehicle is close to a right line that defines the traveling lane.

10. The mobile body according to claim 9, wherein
the stopped vehicle information further includes a distance indicating any amount of protrusion from the left line or the right line into the traveling lane, and
the at least one processor is configured to execute the instructions to determine an amount of avoidance for avoiding the stopped vehicle in accordance with the distance included in the stopped vehicle information.

11-19. (canceled)

20. An avoidance path calculation method comprising:
acquiring stopped vehicle information regarding a stop situation of a stopped vehicle stopped in front of a mobile body capable of automated driving, the stopped vehicle information including information regarding a width and a length of the stopped vehicle, a position of the stopped vehicle in a lane in which the mobile body is traveling, and a stop state of the stopped vehicle;
generating an avoidance path for the mobile body to travel while avoiding the stopped vehicle based on the stopped vehicle information; and
setting the avoidance path in the mobile body.

21. (canceled)
